(19) United States
(12) Patent Application Publication
(10) Pub. No.: US 2018/0087671 A1
(43) Pub. Date: Mar. 29, 2018

(54) VALVE FOR PRESSURIZED FLUID

(71) Applicant: L'Air Liquide, Société Anonyme pour l'Etude et l'Exploitation des Procédés Georges Claude, Paris (FR)

(72) Inventor: Olivier ONDO, Rosny sur Seine (FR)

(73) Assignee: L'Air Liquide, Société Anonyme pour l'Etude et l'Exploitation des Procédés Georges Claude

(21) Appl. No.: 15/710,465

(22) Filed: Sep. 20, 2017

(30) Foreign Application Priority Data
Sep. 26, 2016 (FR) 1659018

(51) Int. Cl. F16K 1/30

(52) U.S. Cl. CPC F16K 1/306; F17C 2205/0338; F17C 2205/0329; F16K 1/307

(57) ABSTRACT

Valve for pressurized fluid, comprising a body housing a fluid circuit that has an upstream end and a downstream end, the circuit including a valve mechanism for controlling the flow rate, the valve mechanism being controlled by a lever mounted on the body housing so as to pivot between a rest position, a first state, and an active position, a second state, the lever including a gripping portion extending in a longitudinal direction between a lower terminal end and an upper terminal end, the gripping portion being configured to be handled, the lever also including a mounting portion mounted on the body in an articulated manner at at least one rotation axis, the mounting portion being connected to the gripping portion and extending transversely with respect to the gripping portion, wherein the mounting portion is connected to the gripping portion at a central part of the gripping portion.

### CROSS REFERENCE TO RELATED APPLICATIONS

This application claims the benefit of priority under 35 U.S.C. § 119 (a) and (b) to French Patent Application No. 1659018, filed Sep. 26, 2016, the entire contents of which are incorporated herein by reference.

### BACKGROUND

The invention relates to a valve for pressurized fluid and to a tank comprising such a valve.

### SUMMARY

More particularly, the invention relates to a valve for pressurized fluid, with or without an integrated pressure regulator, comprising a body housing a fluid circuit that has an upstream end intended to be placed in communication with a reserve of pressurized fluid and a downstream end intended to be placed in communication with a user appliance, the circuit comprising a valve mechanism for controlling the flow rate in the circuit, the valve mechanism being controlled by a lever mounted on the body of the valve so as to pivot between a rest position, in which the valve mechanism is kept in a first state corresponding to a first flow-rate value in the circuit, and an active second position, in which the lever moves the valve mechanism into a second state corresponding to a second flow-rate value in the circuit, the lever comprising a gripping portion extending in a longitudinal direction between a lower terminal end and an upper terminal end, the gripping portion being intended to be handled, the lever also comprising a mounting portion mounted on the body in an articulated manner at at least one rotation axis, the mounting portion being connected to the gripping portion and extending transversely with respect to the gripping portion.

The document FR2828922A1 describes an example of a lever-operated valve.

For mechanical and/or aesthetic reasons, it may be necessary to modify the length of such a lever.

The increase in length of such a valve can cause valve integration problems (into a protective bonnet, for example). Similarly, the forces generated by the torque of the lever can be relatively large.

A continuous objective is to improve the compactness and/or ergonomics in use of such lever-operated valves without having a negative impact on the aesthetic appearance thereof.

An aim of the present invention is to remedy all or some of the drawbacks of the prior art that are set out above.

To this end, the valve according to the invention, which is otherwise in accordance with the generic definition given in the preamble above, is essentially characterized in that the mounting portion is connected to the gripping portion at a central part of the gripping portion, that is to say between said lower terminal end and upper terminal end.

Moreover, embodiments of the invention may include one or more of the following features:
the mounting portion is connected to the gripping portion at a distance of between two and ten centimetres from the upper terminal end, notably between four and nine centimetres,
in side view, the structure of the lever that is formed by the gripping portion and mounting portion is in the overall shape of a T, the attachment portion forming the leg of the T,
the mounting portion is articulated to the body at a rotation axis situated at a terminal end of the attachment portion and at a distance of three to ten centimetres, notably four to nine centimetres, from the gripping portion,
at least one of the mounting portion and the gripping portion is rectilinear and/or angled and/or curved,
the body of the valve comprises a slot, at least a part of the mounting portion being housed and able to move in said slot,
in at least one of the following positions: the rest position, the active position, and an intermediate position between the rest position and active position, at least a part of the gripping portion is accommodated in said slot,
in the use configuration, the outer surface of the valve comprises an upper surface and a lateral surface, and the slot is formed in the lateral surface and/or in the upper surface,
the slot has dimensions and a shape that match the dimensions and shape of the part(s) of the lever that it receives,
the valve has an outer casing connected to the outer surface of the body of the valve, the slot being formed at least partially in said casing.

The invention also relates to a tank comprising a valve in accordance with any one of the features above or below.

The invention may also relate to any alternative device or method comprising any combination of the features above or below.

### BRIEF DESCRIPTION OF THE DRAWINGS

Further particular features and advantages will become apparent from reading the following description, which is given with reference to the figures, in which:

FIG. 1 shows a schematic and partial perspective view illustrating an example of the structure of a lever in accordance with one embodiment of the current invention,

FIG. 2 shows a schematic and partial side view illustrating an example of the structure of a valve incorporating such a lever, in accordance with one embodiment of the current invention,

FIG. 3 shows a schematic and partial top view illustrating an example of the structure of the valve in FIG. 2, in accordance with one embodiment of the current invention

### DESCRIPTION OF PREFERRED EMBODIMENTS

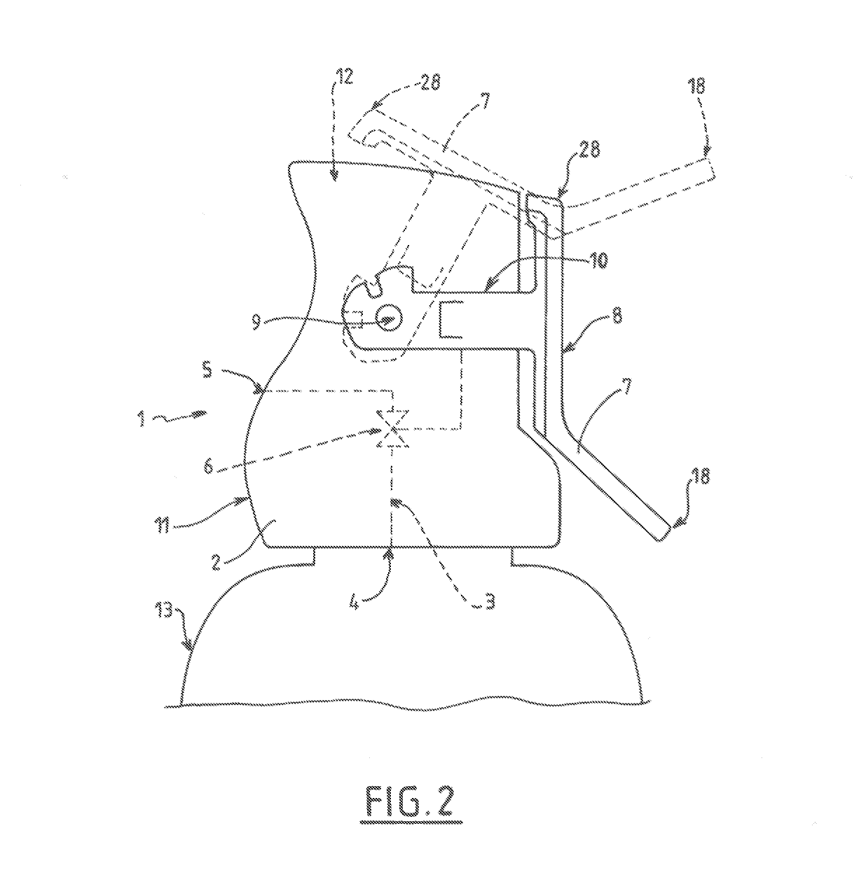

The valve 1 shown in FIG. 2 comprises a body 2 conventionally housing a fluid circuit 3 that has an upstream end 4 intended to be placed in communication with a reserve of pressurized fluid (a cylinder 13 or a set of cylinders for example) and a downstream end 5 intended to be placed in communication with a user appliance for the gas supplied by the reserve of pressurized fluid.

The circuit 3 conventionally comprises a valve mechanism 6 for controlling the flow rate in the circuit 3. This valve mechanism 6 may be an isolation shutter for opening or closing the circuit 3 and/or a shutter for regulating a flow rate or a pressure or any other type of appropriate shutter.

The valve mechanism 6 is controlled by a lever 7 mounted on the body 2 of the valve 1 so as to pivot (for example at at least one articulation 9).

The lever 7 is able to move between a rest position (shown by way of solid lines in FIG. 2) in which the valve 6 is kept in a first state corresponding to a first flow-rate value in the circuit 3 (for example a zero flow rate) and an active second position (shown by way of dotted lines in FIG. 2) in which the lever 7 moves the valve mechanism 6 into a second state corresponding to a second flow-rate value in the circuit 3 (for example circuit completely open for a maximum flow rate).

The member 6 for controlling the flow rate in the circuit 3 that is shown in the figures comprises a valve mechanism 6, but any other member 6 for controlling the flow rate could be envisaged.

For example, in a variant or in combination, the valve 2 could comprise a movable part such as a shutter driver, the movement of which is controlled by the lever 7. This shutter driver (which is able to move in translation, for example) may be provided for example in order to actuate (notably open) a system of shutter(s) situated on another valve or a cylinder to which the valve 1 is connected in order to remove or transfer pressurized fluid.

The lever 7 comprises a gripping portion 8 that extends in a longitudinal direction between a lower terminal end 18 and an upper terminal end 28. The term “gripping portion 8” defines that part of the lever 7 that is intended to be handled by and/or accessible to a user. For example, in practice, only the lower part of this gripping portion 8 is manually handled.

The lever 7 also comprises a mounting portion 10 that is mounted on the body 2 in an articulated manner at at least one rotation axis 9.

The mounting portion 10 is connected to (for example welded to or in one piece with) the gripping portion 8.

This mounting portion 10 extends transversely from the gripping portion 8.

The “gripping portion 10” denotes that part of the lever 7 which is not intended to be handled and/or which is not visible but which connects the lever 7 to the body 2 of the valve and the rest of the mechanism of the latter.

According to one advantageous particular feature, the mounting portion 10 is connected to the gripping portion 8 at a central part of the gripping portion, that is to say between said terminal ends 18, 28. This means that the rotation axis 9 is offset with respect to the upper end 28 of the gripping portion 8 in the longitudinal direction of this gripping portion.

Thus, in the rest position, the rotation axis 9 is situated vertically below the upper end 28 of the gripping portion of the lever 7. This means that the lever 7 can have a relatively large and long gripping portion, without there being a need to provide too much of a lever arm (that is to say that the distance between the rotation axis 9 and the lower end 18 of the gripping portion 8 may be relatively limited).

This makes it possible to provide a lever 7 that has relatively large dimensions (gripping portion 8, notably), while making it possible to locate the rotation axis 9 centrally in or on the body 2 of the valve (cf. FIG. 2).

This makes it possible to reduce the size or optimize the compactness of the valve 1 (notably in order to integrate it into a protective bonnet or any other environment).

For example, the structure of the lever 8 formed by the gripping portion 8 and mounting portion 10 thus has the overall shape of a T, the attachment portion 10 forming the base or “leg” of the T.

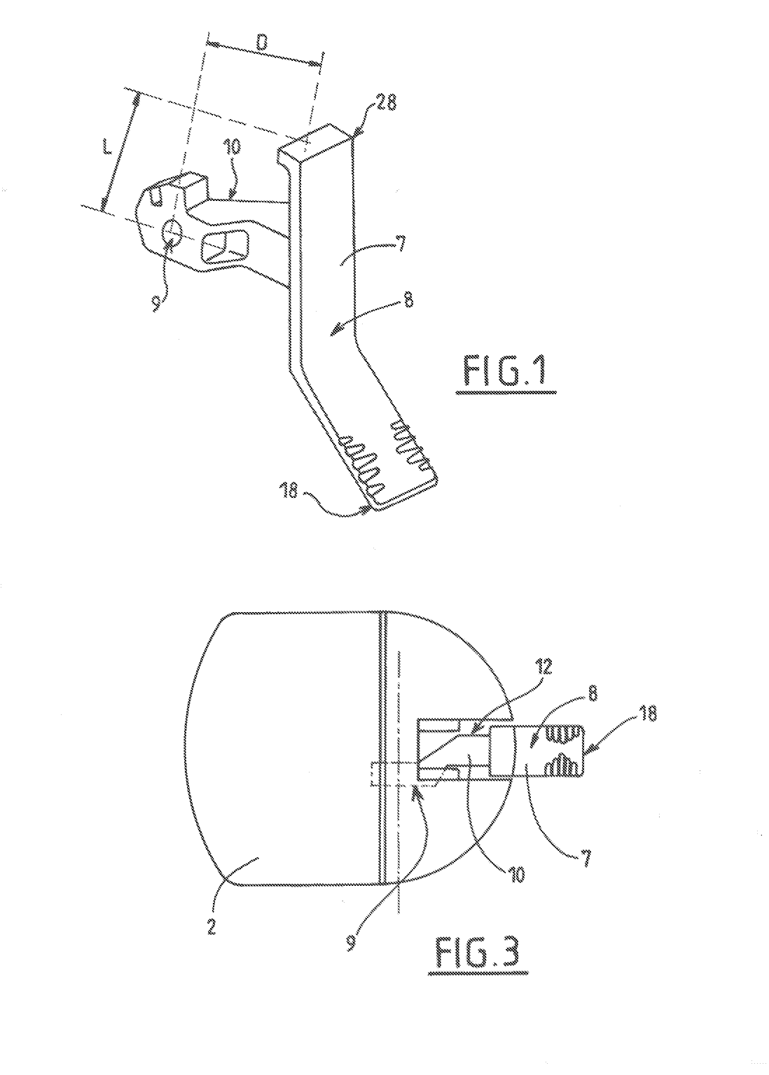

For example, the mounting portion 10 is connected to the gripping portion 8 at a distance L of between two and ten centimetres from the upper terminal end 28 (cf. FIG. 1).

Similarly, the mounting portion 10 can be articulated to the body 2 at a rotation axis 9 situated at a terminal end of the mounting portion 10 and at a transverse distance D of between three and ten centimetres from the gripping portion 8.

As illustrated, at least one of the mounting portion 10 and the gripping portion 8 is rectilinear and/or angled and/or curved. In particular, when the gripping portion is said notably to extend “in a longitudinal direction”, this should not be understood as being limiting (rectilinear). On the contrary, the gripping portion 8 can be angled or curved while extending in a generally longitudinal direction.

As illustrated in FIGS. 2 and 3, without otherwise being limiting, the body 2 of the valve can comprise a slot 12, for example a central slot, and at least a part of the mounting portion 10 is at least partially accommodated (and moves) in this slot 12.

According to this configuration, the upper part of the gripping portion 8 of the lever 7 (situated above the rotation axis 9) can thus form a cover that conceals a part of the slot 12 (cf. the two positions in FIG. 2).

The upper part of the gripping portion 8 can notably form a screen that limits the penetration of dirt into the slot 12.

In the use configuration, the outer surface of the valve 1 comprises an upper surface and a lateral surface, and the slot 12 can be formed in the lateral surface and/or in the upper surface.

As illustrated in FIGS. 2 and 3, in at least one of the following positions: the rest position, the active position, and an intermediate position between the rest position and active position, at least a part of the gripping portion 8 is accommodated in said slot 12.

Preferably, the slot 12 has dimensions and a shape that match the dimensions and shape of the part(s) of the lever 7 that it receives. This improves the compactness of the valve without impairing its appearance.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A valve for pressurized fluid, comprising a body housing a fluid circuit comprising an upstream end configured to be placed in communication with a reserve of pressurized fluid and a downstream end configured to be placed in communication with a user appliance, the fluid circuit comprising a valve mechanism for controlling the flow rate in the fluid circuit, the valve mechanism being controlled by a lever mounted on the body housing so as to pivot between a rest position, in which the valve mechanism is kept in a first state corresponding to a first flow-rate value in the fluid circuit, and an active second position, in which the valve mechanism is kept in a second state corresponding to a second flow-rate value in the fluid circuit, the lever comprising a gripping portion extending in a longitudinal direction between a lower terminal end and an upper terminal end, the gripping portion configured to be manually handled, the lever also comprising a mounting portion mounted on the body housing in an articulated manner at at least one rotation axis, the mounting portion being connected to the gripping portion and extending transversely with respect to the gripping portion, wherein the mounting portion is connected to the gripping portion at a central part of the gripping portion, the central part being between the lower terminal end and the upper terminal end.

2. The valve of claim 1, wherein the mounting portion is connected to the gripping portion at a distance of between two and ten centimetres from the upper terminal end.

3. The valve of claim 1, wherein, in side view, the structure of the lever that is formed by the gripping portion and mounting portion is in the overall shape of a T, the mounting portion forming the leg of the T.

4. The valve of claim 1, wherein the mounting portion is articulated to the body housing at the rotation axis situated at a terminal end of the attachment portion and at a distance of three to ten centimetres from the gripping portion.

5. The valve of claim 1, wherein at least one of the mounting portion and the gripping portion is rectilinear and/or angled and/or curved.

6. The valve of claim 1, wherein the body housing comprises a slot, and in that at least a part of the mounting portion is housed and able to move in said slot.

7. The valve of claim 6, wherein, in at least one of the following positions: the rest position, the active position, and an intermediate position between the rest position and active position, at least a part of the gripping portion is accommodated in said slot.

8. The valve of claim 6, wherein, in the use configuration, the outer surface of the valve comprises an upper surface and a lateral surface, and in that the slot is formed in the lateral surface and/or in the upper surface.

9. The valve of claim 6, wherein the slot has dimensions and a shape that match the dimensions and shape of the complementary part(s) of the lever.

10. The valve of claim 6, further comprising an outer casing connected to the outer surface of the body housing, and in that the slot is formed at least partially in said casing.

11. A pressurized-fluid tank comprising a valve, wherein the valve is in accordance with claim 6.
